(19) United States
(12) Patent Application Publication
(10) Pub. No.: US 2004/0093939 A1
(43) Pub. Date: May 20, 2004

(54) Non-contact level detector for fluids in a container

(76) Inventor: Herman Diaz Arias, Atizapan (MX)

Correspondence Address: BAKER BOTTS L.L.P., 2001 ROSS AVENUE, SUITE 600, DALLAS, TX, 75201-2980, US

(21) Appl. No.: 10/294,972

(22) Filed: Nov. 14, 2002

(51) Int. Cl. G01F 23/00

(52) U.S. Cl. 73/290 R

(57) ABSTRACT

The present invention includes a level detector having a collimator being operable to block first electromagnetic radiation having a first range of orientations with respect to the level detector from passing through. The collimator is further operable to allow second electromagnetic radiation having a second range of orientations with respect to the level detector to pass through. The level detector includes a sensor that is positioned, with respect to the collimator, such that the sensor is operable to detect magnitudes of the second electromagnetic radiation. The sensor may be further operable to convert incident photon flux associated with the second electromagnetic radiation to electrical signals. In accordance with a particular embodiment of the present invention, the level detector includes an electronic unit that is operable to detect a radiation step in the second electromagnetic radiation, based upon changes in the magnitudes of the second electromagnetic radiation.

### TECHNICAL FIELD OF THE INVENTION

This invention relates to measurement devices, and more particularly to a level detector for measuring the level of a fluid in a container.

### BACKGROUND OF THE INVENTION

Level detection is used in a vast number of applications to monitor the level of liquid, gas or other material in a container. Typically, a probe or transducer is installed within the container. Many traditional level sensors require the installation of a probe inside the container. Such sensors cannot be used in tanks that are not specifically designed for the particular sensor.

In the gas industry, for example, a widely used level measuring device is a float level meter. This type of meter requires the installation of a float inside the tank. The float is connected to the body of the meter by a metal arm. The arm allows the position of the interface between the liquified gas and gas which is in a gaseous state to be monitored. The movement of the float is translated to a rotational displacement by the arm. The displacement of the arm requires quite a bit of space, making it difficult to use this type of level meter in small tanks (e.g., gas grill, and portable tanks).

### SUMMARY OF THE INVENTION

The present invention provides a level detector and method of level detection for materials contained in tanks that substantially eliminates or reduces at least some of the disadvantages and problems associated with the previous level detectors and methods.

In accordance with a particular embodiment of the present invention, a level detector is provided. The level detector includes a collimator being operable to block first electromagnetic radiation having a first range of orientations with respect to the level detector from passing through. The collimator is further operable to allow second electromagnetic radiation having a second range of orientations with respect to the level detector to pass through. The level detector also includes a sensor positioned, with respect to the collimator, such that the sensor is operable to detect magnitudes of the second electromagnetic radiation. The sensor may be further operable to convert incident photon flux associated with the second electromagnetic radiation to electrical signals.

In accordance with another embodiment of the present invention, the sensor is electrically coupled with an electronic unit. The electronic unit is operable to detect a radiation step in the second electromagnetic radiation, based upon changes in the magnitudes of the second electromagnetic radiation.

In accordance with yet another embodiment of the present invention, a method for detecting a level of fluid in a container includes scanning a surface of the container with a remote sensor, the container having a gas and a liquid within the container. The method also includes measuring radiation intensities along the surface of the container. Variations in radiation intensities may be identified adjacent at interface between the gas and the liquid.

Technical advantages of particular embodiments of the present invention include a level detector that may be used to detect a level of fluid in a container of practically any material, without touching the container. Operation of such a level detector may be conducted remotely, from a distance of a few inches to several miles from the container.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 is a diagram illustrating a level detector and a tank in accordance with an embodiment of the present invention;

FIG. 2 is a diagram illustrating a relationship between IR radiation/temperature, and the location along the surface of the container of FIG. 1;

FIG. 3 is a schematic diagram illustrating circuits suitable for use within the teachings of the present invention;

FIG. 4 is a schematic diagram illustrating various components which may be utilized in accordance with the teachings of the present invention;

FIG. 5 is a schematic diagram illustrating the operation of a collimator of the level detector of FIG. 1, in accordance with a particular embodiment of the present invention; and

FIG. 6 illustrates top and side views of a level detector incorporating aspects of the present invention.

### DETAILED DESCRIPTION OF THE INVENTION

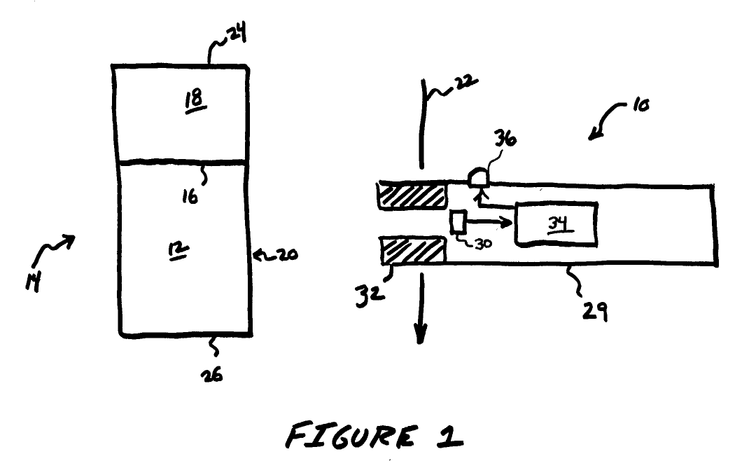

FIG. 1 illustrates a level detector 10 in accordance with a particular embodiment of the present invention. Level detector 10 may be used to determine the level of a fluid 12 in a container 14. In various embodiments of the present invention, container 14 may be a variety of shapes and sizes. Furthermore, container 14 may be sealed, and include the capability to maintain pressure exerted from various fluids contained therein.

For the purposes of this description, container 14 will be described as a sealed container able to withstand pressure differentials between its contents, and ambient environment. The level of liquid 12 in container 14 is defined by interface 16 between fluid 12 and fluid 18. Since fluid 18 is collected near the top of container 14, it is evident that fluid 18 is less dense than fluid 12. For example, fluid 12 may represent a liquid, such as liquid propane. Also in this embodiment, liquid 18 may comprise a gas, such as propane gas, air, or some combination thereof. As will be described later in more detail, level detector 10 may be used to detect the interface 16 between fluid 12 (liquid) and fluid 18 (gas).

Level detector 10 may be used to scan the surface 20 of container 14 vertically, as indicated by directional arrow 22. Furthermore, level detector 10 may scan surface 20 using a vertical sweeping motion, along surface 20 of container 14, back and forth between the top 24 and bottom 26 of container 14. In a particular embodiment of the present invention, the scanning movement of level detector 10 is made beginning from the top 24 or the bottom 26 of container 14 until interface 16 between gas 18 and liquid 12 inside container 14 is detected.

Level detector 10 reads electromagnetic radiation that is radiated from the surface 20 of container 14. The radiation detected at any point along surface 20 is approximately proportional to the temperature of the material that makes up container 14 at a specific point along surface 20. This type of radiation may be referred to as long wavelength infrared radiation. Long wavelength infrared radiation may be measured using sensors that convert an incident photon flux associated with the electromagnetic radiation, into an electrical signal. Different types of sensors may be used for this purpose, for example, thermal sensors and quantum sensors.

A thermal sensor is one which absorbs incident radiation flux. The energy provided by the flux increases the temperature of the sensor. The increase in temperature thereby changes a measurable physical property of a component of the sensor, for example, voltage and/or resistance.

A quantum sensor, on the other hand, senses radiation in a different way. A quantum sensor employs a semiconductor crystal. The incident photon flux interacts with a crystal lattice of the semiconductor crystal. This generates free electrons or carriers, which changes the electrical balance, and produces a signal voltage in the sensing element.

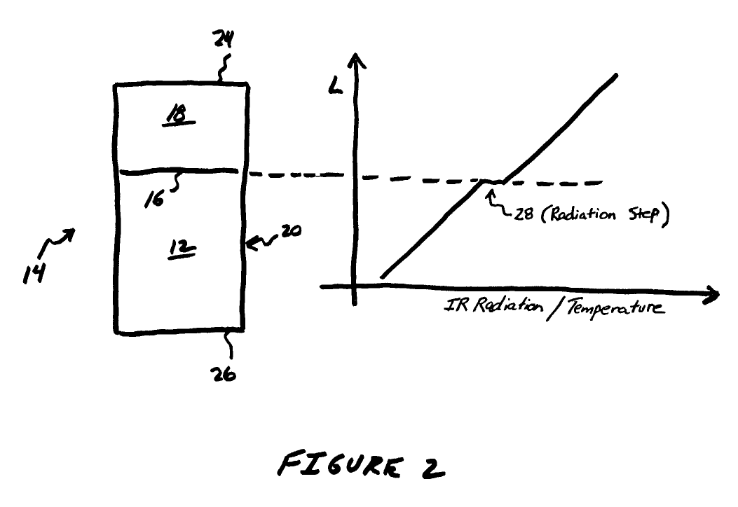

These types of sensors may be used to detect interface 16, because the temperature over surface 20 of container 14 is not equal at every spot. Instead, the temperature over surface 20 generally has a geometric distribution which increases or decreases along vertical axis 22. In a particular embodiment, where the container is partially filled with a liquid such as fluid 12, a step in the temperature distribution may be detected at interface 16 where liquid 12 and gas 18 make contact. The temperature distribution along surface 20 of container 14 will be described in more detail with regard to FIG. 2.

FIG. 2 illustrates a particular thermal distribution that may occur along surface 20 of container 14, and the infrared radiation corresponding to the temperature. Vertical axis L of FIG. 2 corresponds to the distance vertically upward along surface 20 of container 14. A radiation step 28 is evident at the location of interface 16 between liquid 12 and gas 18. The vertical thermal distribution illustrated in FIG. 2 is generated by the physical convection in liquid 12 and gas 18 contained in container 14. Convection is stronger in liquids, which makes temperature distribution in the “wet” zone different.

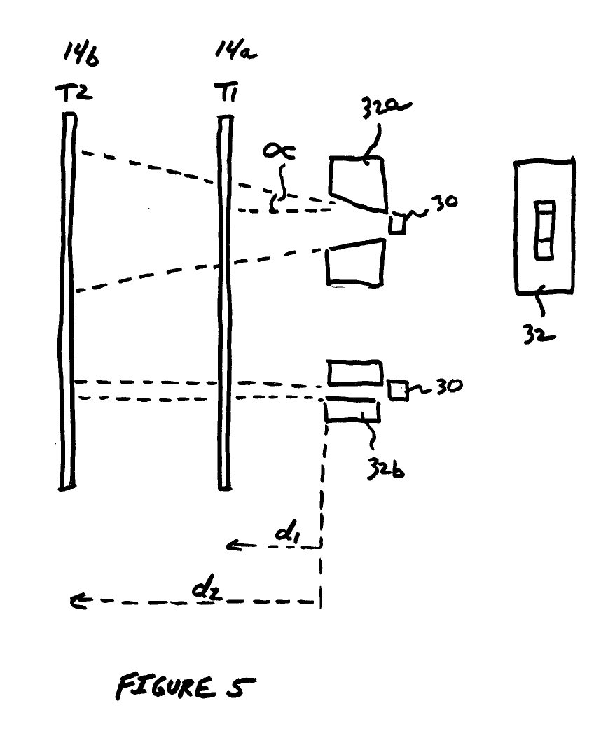

Referring again to FIG. 1, level detector 10 includes an elongate housing 29 having a thermal sensor disposed at least partially therein. Thermal sensor 30 receives electromagnetic radiation that is radiated from surface 20 of container 14. In the illustrated embodiment, a collimator 32 is used to allow only radiation that is generally perpendicular to the sweeping axis (e.g., vertical axis 22) to penetrate inside of level detector 10 and be exposed to thermal sensor 30. A particular collimator suitable for use within the teachings of the present invention is described in more detail in FIG. 5.

Thermal sensor 30 converts such incoming infrared radiation to a voltage signal that is processed by an electronic unit 34. In accordance with a particular embodiment of the present invention, when detector 10 is perpendicular to liquid interface 16, a signal 36 is generated. Signal 36 may be an audible signal (e.g., audible alarm), or a light (visual) signal.

Thermal and quantum radiation sensors, such as thermal sensor 30, are also sometimes known as thermopile and pyroelectric sensors. These type of sensors often need a “warm-up,” after they are first activated. For example, some such sensors require up to sixty seconds of warm-up in order to function properly. This can be problematic if the operator intends, or needs to use the sensor immediately after it is powered on. In this case, signals that are generated internal to the sensor during the warm-up period must be compensated with an electronic circuit. This electronic circuit is used to separate signals coming from outside the detector from warm-up signals generated inside the detector during the warm-up period.

The signal generated by thermal sensor 30 may be very small. In this case, the signal must be amplified. The amplifier used to accomplish this may have a very high gain, combining DC and low frequency response. The exact combination of gain and frequency response compensates for variations in scanning speed. For example, if the sweeping speed of level detector 10 is not fairly uniform, variations of that speed can give false “step” (e.g., radiation step) readings.

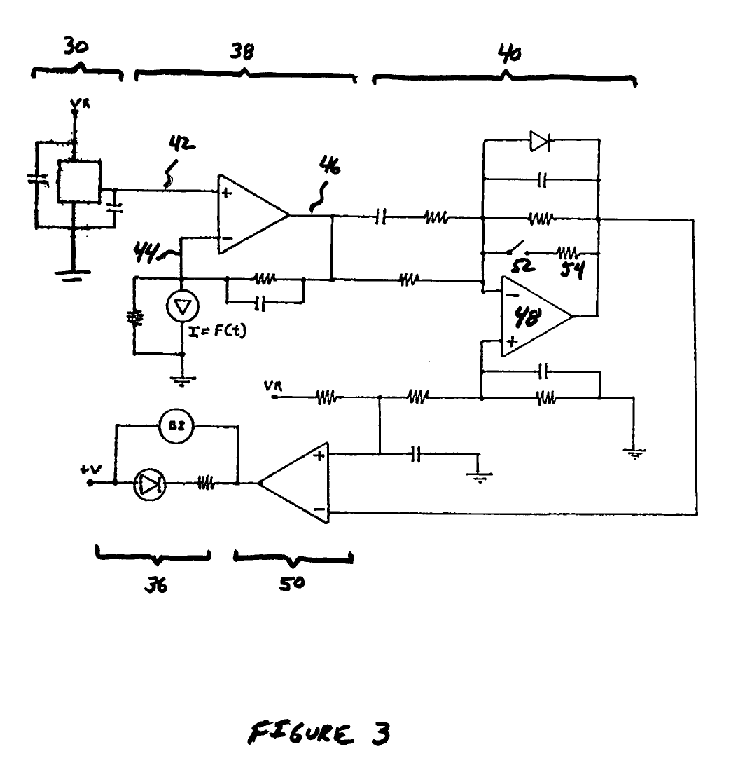

FIG. 3 is an electronic circuit diagram that illustrates aspects of the circuitry of thermal sensor 30, a compensating circuit 38, and a sweep stabilization network 40. As illustrated in FIG. 3, sensor 30 is coupled to “warm-up” compensating circuit 38. Compensating circuit 38 is amplified with two inputs 42, 44. Input 42 is connected to the output of sensor 30. Input 44 receives a short duration signal opposed to that of thermal sensor 30. In this embodiment, the compensating period is less than forty seconds. Output 46 is connected to sweep stabilization network 40. In this configuration, sweeping speeds from 0.2 m/sec to lm/sec will not affect the detection of interface 16 of container 14.

An amplifier 48 and a voltage comparator 50 activate signal 36, to indicate that interface 16 is approximately perpendicular to level detector 10. This indicates that the level of liquid inside the container is approximately in front of the thermal sensor 30. In a particular embodiment of the present invention, visual signal 36 can be a narrow, focused light-emitting diode. Such a diode may be used to automatically project a light spot on the surface 20 of container 14, to indicate the exact level of the liquid, or the precise location of interface 16.

A switch 52 and a resistor 54 may be used to alter the detector's sensitivity. This allows level detector 10 to detect liquid levels in containers either stored or in use. This is helpful because the radiation step, for example radiation step 28, at interface 16 is stronger when a gas tank is in use, because of a decrease of pressure inside the tank. The decrease in pressure lowers the temperature of the gaseous material inside.

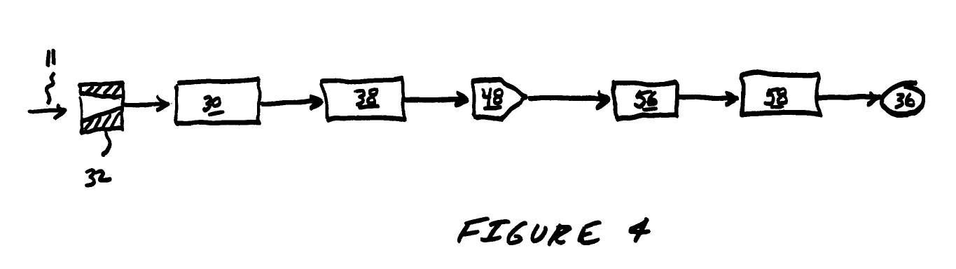

FIG. 4 illustrates a system and method for improving sweep variation during operation of level detector 10. This solution also improves the immunity of level detector 10 to ambient temperature. In accordance with FIG. 4, radiation 11 passes through collimator 32 and contacts thermal sensor 30, as described above. Compensating circuit 38 corrects for any warm-up “noise” generated by components of level detector 10. The signal received by amplifier 48 is amplified and subsequently received at an analog to digital converter 56. Analog to digital converter 56 allows the signal to be digitally processed.

The signal is then received at a micro-controller 58. Micro-controller 58 takes readings, or “samples” incoming infrared radiation several times per second. Micro-controller 58 uses these readings to calculate the rate of change of the incoming infrared radiation. This allows micro-controller 58 to identify a “step,” in that rate, for example, radiation step 28 of FIG. 2.

Micro-controller 58 allows the magnitude of the radiation step to be predetermined, such that microcontroller 58 will automatically look for a particular magnitude of radiation step. Once a radiation step equal to or greater than a predetermine magnitude is identified, micro-controller 58 initiates signal 36. Signal 36 alerts the operator that the detector is directly in front of, or perpendicular to the interface 16 between liquid 12 and gas 18.

FIG. 5 illustrates a system and method for compensating for variations in the input radiation that correspond to unintentional movements that the operator makes during the scanning process, in accordance with a particular embodiment of the present invention. To obtain the most accurate readings using level detector 10, it is helpful that the scanning direction of level detector 10 is vertical. It is also helpful to maintain an equal distance between level detector 10 and container 14 during scanning. This is due to the fact that radiation intensity is distance-dependent.

Collimator 32 of FIG. 5 allows for horizontal movement of level detector 10 by an operator, without affecting accurate level detection. Collimator 32 controls the amount of radiation that reaches thermal sensor 30. Reference number 32a illustrates a horizontal cross-section of collimator 32. Similarly, reference number 32b illustrates a vertical cross-section through collimator 32.

Targets T1 and T2 represent targets (e.g., containers 14a, 14b) set at different distances from collimator 32. Distance dl illustrates the distance between collimator 32 and target T1. Distance d2 illustrates the distance between collimator 32 and target T2. As illustrated in FIG. 5, the area of the target detected by sensor 30 does not vary with distance dl and d2 if only the vertical cross-section 32b of collimator 32 is considered. However, the area of the target sensed does vary according to the angle α and the distance dl and d2 in the horizontal plane illustrated by cross-section 32a of collimator 32.

In accordance with the present invention, it is possible to design collimator 32 with an angle a that automatically compensates for variation of intensity caused by moving the sensor closer or farther with a smaller or wider input window, respectively. This type of collimator compensates by incorporating a wider area of the target as the sensor moves away from it, but only in the horizontal plane. No vertical compensation should be made, because the sensor is attempting to detect a step in radiation along the vertical plane. In accordance with a particular embodiment of the present invention, collimator 32 is made of materials that are opaque for wavelengths used in level detector 10. In accordance with various embodiments, the wavelength used in level detector 10 may comprise 4-14 microns.

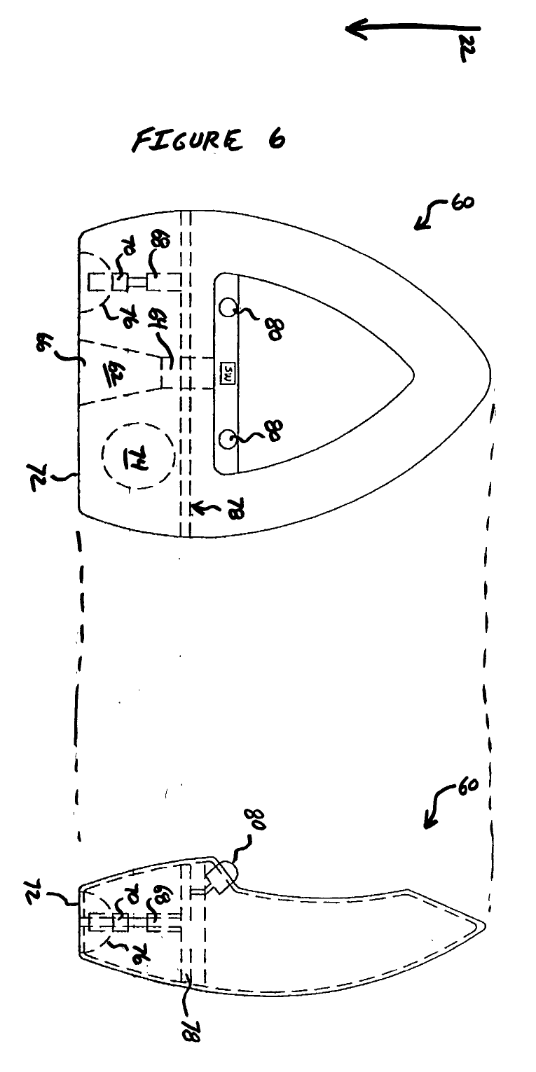

FIG. 6 illustrates a level detector 60, that incorporates aspects of the present invention. Level detector 60 includes a collimator/wave guide 62 that controls the amount of radiation that reaches thermal sensor 64. In essence, collimator wave guide 62 is a free window with thermal sensor 64 placed at one end.

Due to the design of level detector 60, there is no protection provided in front of thermal sensor 64, in the illustrated embodiment. This is due to the fact that materials that are transparent to wavelengths are very expensive. Such materials cannot be glued, and are difficult to handle. Therefore, the enclosure of level detector 60 illustrated in FIG. 6, is designed to allow level detector 60 to be placed over any horizontal surface with the collimator/wave guide 62 entrance 66 facing down. This avoids contamination from dust and other particles that may reach thermal sensor 64 when level detector is not in use.

Level detector 60 includes a switch 68 that is used to toggle level detector 60 between the “on” and “off” positions. Switch 68 includes a shaft 70 that projects from the bottom plane 72 of level detector 60, when the power is on. In the illustrated embodiment, shaft 70 projects approximately 5-7 millimeters from bottom plane 72. This prevents level detector 60 from being placed horizontally with entrance 66 facing down when switch 68 is in the “on” position. This eliminates the possibility that battery 74 can discharge when level detector 60 is not in use. When switch 68 is off, shaft 70 will remain recessed with respect to horizontal surface 72, within a spherical void area 76. Spherical void area 76 allows a fingertip of the operator to activate the switch to the “on” position.

Level detector 60 includes a printed circuit board 78. Printed circuit board 78 and all electronics are placed near horizontal plane 72, in order to lower the center of gravity of level detector 60, which provides stability to the body of level detector 60 when it is placed over a flat surface.

Two light indicators, or sensors 80 are mounted in a 45-degree angle with respect to the line of scanning, in order to direct the signal light to the eyes of the operator. Light indicators 80 can be installed facing in the direction of the target (e.g., container) in order to project a light spot on the surface of the container, to indicate the level of liquid inside.

Although the present invention has been described in detail, various changes and modifications may be suggested to one skilled in the art. It is intended that the present invention encompass such changes and modifications as falling within the scope of the appended claims.

What is claimed is:

1. A level detector, comprising:
a collimator being operable to block first electromagnetic radiation having a first range of orientations with respect to the level detector from passing through, and being further operable to allow second electromagnetic radiation having a second range of orientations with respect to the level detector to pass through;
a sensor being positioned, with respect to the collimator, such that the sensor is operable to detect magnitudes of the second electromagnetic radiation; and
the sensor being operable to convert incident photon flux associated with the second electromagnetic radiation to electrical signals.

2. The level detector of claim 1, wherein the sensor comprises a thermal sensor.

3. The level detector of claim 1, wherein the sensor comprises a quantum sensor.

4. The level detector of claim 1, further comprising an electronic unit being operable to process the electrical signals.

5. The level detector of claim 4, wherein the electronic unit is further operable to detect a radiation step in the second electromagnetic radiation, based upon changes in the magnitudes of the second electromagnetic radiation.

6. The level detector of claim 5, further comprising a signal, wherein the signal is operable to actuate in response to detection of the radiation step.

7. The level detector of claim 6, wherein the signal comprises an audible signal.

8. The level detector of claim 6, wherein the signal comprises a visual signal.

9. The level detector of claim 8, wherein the signal comprises a light emitting diode being operable to project a light beam upon a surface of a container from which at least a portion of the second electromagnetic radiation is emanating, at approximately a location of the radiation step.

10. The level detector of claim 1, further comprising an amplifier being operable to amplify the electrical signals.

11. The level detector of claim 1, further comprising a voltage comparator being operable to compare voltages associated with the electrical signals.

12. The level detector of claim 4, further comprising a switch and a resistor, the switch and resistor providing an operator with the ability to adjust a sensitivity of the level detector.

13. The level detector of claim 4, wherein the electronic unit comprises a compensating circuit being operable to correct for warm-up noise generated by components of the level detector during a warm up period.

14. The level detector of claim 4, wherein the electronic unit comprises an analog to digital converter being operable to convert the electrical signals to corresponding digital signals.

15. The level detector of claim 14, further comprising a micro-controller being operable to receive the digital signals, and calculate a rate of change of the magnitudes of the second electromagnetic radiation.

16. The level detector of claim 1, wherein a window of the collimator is tapered along a horizontal cross section to at least partially correct for inadvertent horizontal movement by an operator of the level detector.

17. A method for detecting a level of fluid in a container, comprising:
scanning a surface of a container with a remote sensor, the container having a gas and a liquid within the container;
measuring radiation intensities along the surface of the container;
identifying a variation in radiation intensities adjacent an interface between the gas and the liquid.

18. The method of claim 17, wherein the sensor comprises a thermal sensor, and further comprising:
absorbing, at the thermal sensor, incident radiation flux from the container, the incident radiation flux being operable to increase a temperature of the sensor thereby changing a measurable physical property of the sensor.

19. The method of claim 18, wherein the measurable physical property comprises a voltage of the sensor.

20. The method of claim 18, wherein the measurable physical property comprises a resistance of the sensor.

21. The method of claim 17, wherein the sensor comprises a quantum sensor, and further comprising:
absorbing incident photons from the container;
exposing the photons to a semiconductor crystal;
the photons being operable to interact with a crystal lattice of the semiconductor crystal and generate free electrons or carriers; and
producing a signal voltage in the sensor.

22. The method of claim 17, further comprising compensating for a scanning speed of the sensor using high amplification and low noise electronics.

23. The method of claim 17, further comprising separating first signals originating outside the detector from second signals generated inside the sensor to compensate for warm-up of the sensor.

24. The method of claim 17, further comprising activating a sonic or visual signal when the interface is detected.

25. The method of claim 24, wherein the signal comprises a light emitting diode, and further comprising:
projecting a light spot on the surface of the container at approximately the location of the interface.

26. A method for detecting a level of fluid in a container, comprising:
receiving, at a collimator, first and second electromagnetic radiation, the first electromagnetic radiation having a first range of orientations with respect to the collimator, and the second electromagnetic radiation having a second range of orientations with respect to the collimator;
blocking the first electromagnetic radiation and allowing the second electromagnetic radiation to pass through the collimator;
detecting, at a sensor, magnitudes of the second electromagnetic radiation; and
converting incident photon flux associated with the second electromagnetic radiation to electrical signals.

27. The method of claim 26, further comprising correcting for warm-up noise generated by components of the level detector, using a compensated circuit.

28. The method of claim 27, further comprising amplifying the electrical signals.

29. The method of claim 28, further comprising converting the electrical signals to digital signals.

30. The method of claim 29, further comprising sampling the digital signals and calculating a rate of change.

31. The method of claim 30, further comprising identifying a step in the digital signals of a predetermined magnitude.
